(19) United States
(12) Patent Application Publication
(10) Pub. No.: US 2002/0080493 A1
(43) Pub. Date: Jun. 27, 2002

(54) Polarization-independent ultra-narrow band pass filters

(76) Inventors: Rung-Ywan Tsai, Tao-Yuan Hsien (TW); Hoang-Yan Lin, Keelung Hsien (TW); Yung-Hsin Chen, Taipei Hsien (TW); Chia-Shy Chang, Hsinchu City (TW)

Correspondence Address: RABIN & CHAMPAGNE, P.C., 1101 14 Street, N.W., Suite 500, Washington, DC, 20005, US

(21) Appl. No.: 09/796,707

(22) Filed: Mar. 2, 2001

(30) Foreign Application Priority Data
Dec. 21, 2000 (TW) 89127452

(51) Int. Cl. G02B 27/00

(52) U.S. Cl. 359/584; 359/578

(57) ABSTRACT

A Polarization-independent ultra-narrow band pass filter, which is not sensitive to the polarization state of incident beams of light and can obtain better narrow band pass signals with fewer film layers. The polarization-independent ultra-narrow band pass filter is a stack structure of dual symmetric resonance cavities. Each of the resonance cavities is a structure of high refraction index film layers and low refraction index layers stacked interposedly together. Each of the resonance cavities includes two reflectors and a resonance light grating sandwiched in between. Each film layer of the reflector and the resonance grating is λ/4 thick. The grating periodic length is between 0.9 λ and 3 λ and a preferred grating periodic length is 1 λ to 2 λ, where λ is the wavelength of the incident light. The high refraction index layer of the reflector is a Si layer (refraction index n_{H}-=3.6) and the low refraction index layer is a SiO₂ layer (refraction index n_{L}=1.43). The resonance grating can be a film layer with a high refraction index (with an effective refraction index between 3.4 and 3.5) or a film layer with a low refraction index (with an effective refraction index between 1.45 and 1.5).

### BACKGROUND OF THE INVENTION

1. Field of Invention

The present invention relates to an optical film narrow band pass filter and, in particular, to a polarization-independent ultra-narrow band pass filter.

2. Related Art

Usual narrow band pass filters are composed of a Fabry-Perot structure, also called the Fabry-Perot band pass filters. FIG. 1 shows a thin film Fabry-Perot band pass filter with a single cavity 1 (or resonance cavity). Basically, its structure is composed of two parallel reflectors 2 with a spacer 3 sandwiched in between. The reflector 2 consists of high refraction index layers 4 and low refraction index layers 5 stacked interposedly together (H. A. Macleod, Thin Film Opticalfilters, 2^{nd} ed., Chap.7, pp.234-313, Adam Hilger Ltd., 1986). Each film layer 4, 5 of the reflector 2 can be a medium film or a metal film with an optical thickness of λ/4. To avoid the attenuation of penetrating signals, the spacer 3 is usually made of a medium film that does not absorb penetrating signals with an optical thickness of λ/2. λ means the wavelength of the penetrating light. The penetrating band pass shape of a general thin film Fabry-Perot band pass filter with a single cavity is triangular and the band pass width becomes narrower as the reflection index of the reflector increases. In order to make an ultra-narrow band pass filter, the number of medium film layers that form the reflector has to increase. Nonetheless, increasing the number of the medium film layers cannot make the penetrating band pass shape into an ideal rectangle. To make the penetrating band pass shape narrower and more close to a rectangle, two or more than two thin film Fabry-Perot band pass filters with single cavities have to be stacked together, forming Fabry-Perot band pass filters with two or more cavities. This method does not only increase the manufacturing time and cost, it also increase the number of film layer interfaces. Therefore, existence of interface defects will easily result in band pass shape deformation or penetration decrease in the multi-cavity Fabry-Perot band pass filters.

The U.S. Pat. No. 5,726,805 (S. Kaushik and B. R. Stallard, “Optical filter including a subwavelength periodic structure and method of making”) and the U.S. Pat. No. 5,598,300 (R. Magnusson and S. -S. Wang, “Efficient bandpass reflection/transmission filters with low sidebands based on guided-mode resonance effects”) improve normal thin film Fabry-Perot band pass filters by making the spacer of the single-cavity Fabry-Perot band pass filter into the shape of a resonance wave guide grating and controlling the periodic length Λ and the thickness d of the resonance wave guide grating smaller than the wavelength of the penetrating light and smaller than or equal to the thickness of the spacer, respectively. The resonance wave guide grating penetrating filter uses fewer and thinner narrow band pass filters than usual thin film Fabry-Perot band pass filters. Furthermore, because of its resonance wave guide grating periodic length Λ is smaller than the wavelength of the penetrating light, only the zeroth order diffraction can penetrate through and diffraction waves of other orders do not exist. However, the side band of the resonance wave guide grating penetrating filter with a single cavity in the above-mentioned two patents cannot be very low and narrow. Therefore, there are more noises in the penetrating light. Most important of all, the resonance wave guide grating penetrating filter and the usual thin film Fabry-Perot band pass filters both have the problem of being polarization dependent. That is, the penetrating light will generate signals of different strengths and amplitudes at different incident angles and polarization states.

### SUMMARY OF THE INVENTION

In view of the foregoing, it is an object of the invention to provide a polarization-independent ultra-narrow band pass filter that is not sensitive to the polarization state of the incident light and able to obtain better narrow band pass signals using fewer film layers and smaller thickness. Thus, the present invention can reduce errors and production costs in film coating.

According to the present invention, the disclosed polarization-independent ultra-narrow band pass filter has a stack structure of dual symmetric resonance cavities. Each of the resonance cavities is a structure of high refraction index film layers and low refraction index layers stacked interposedly together. The resonance cavity includes two reflectors and a resonance light grating sandwiched in between. Each film layer of the reflector and the resonance grating is λ/4 thick. The grating periodic length of the resonance grating is between 0.9 λ and 3 λ and a preferred grating periodic length is 1 λ to 2 λ, where λ is the wavelength of the incident light.

According to the above embodiment, the high refraction index layer of the reflector is an Si layer (refraction index n_{H}=3.6) and the low refraction index layer is an SiO₂ layer (refraction index n_{L}=1.43). The resonance grating can be a film layer with a high refraction index (with an effective refraction index between 3.4 and 3.5) or a film layer with a low refraction index (with an effective refraction index between 1.45 and 1.5). The disclosed ultra-narrow band pass filter does not only have very strong high band pass penetrating signals, but can also make the low band pass penetrating signals lower and narrower. The half-bandwidth Δλ of the penetrating signals is smaller than 0.2 nm. Most important of all, the penetrating wavelengths of incident light with different polarizations vary by less than 0.14 nm when the incident angle θ≦±15°. Therefore, the invention can be used in tuners of inorganic or organic lasers, color filters of color display panels (LCD, LED, EL), fiber communication filters, filters of biomedical detectors, etc.

### BRIEF DESCRIPTION OF THE DRAWINGS

The present invention will become more fully understood from the detailed description given hereinbelow illustration only, and thus are not limitative of the present invention, and wherein:

FIG. 1 is the cross-sectional view of a conventional Fabry-Perot band pass filter;

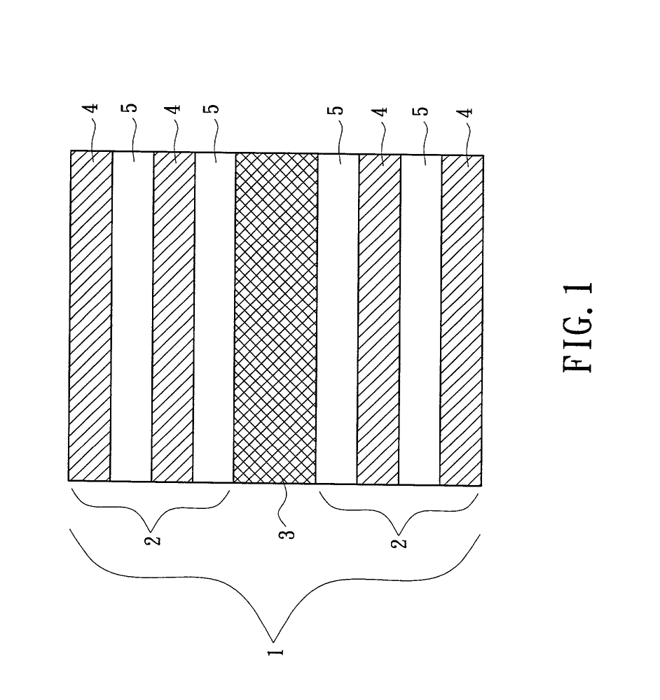

FIG. 2A is the cross-sectional view of a first embodiment polarization-independent ultra-narrow band pass filter, wherein the filter is formed by stacking two symmetric Fabry-Perot band pass filters with single cavities, the spacer of the cavity being a resonance grating and the film next to the resonance grating is a low refraction index layer;

FIG. 2B is the cross-sectional view of a second embodiment polarization-independent ultra-narrow band pass filter, wherein the filter is formed by stacking two symmetric Fabry-Perot band pass filters with single cavities, the spacer of the cavity being a resonance grating and the film next to the resonance grating is a low refraction index layer;

FIG. 3 compares the penetrating rate spectra of a 18-layer polarization-independent ultra-narrow band pass filter of the present invention and usual thin film Fabry-Perot band pass filters with a single cavity (9 layers) and dual cavities (19 layers) when the incident angle is 0;

FIG. 4 illustrates the dependence of the penetrating rate on polarized light in different polarization states (P and S) for the first embodiment filter with 18 layers at 0°10° and 20°, the thickness of each film layer of the filter being λ/4, wherein λ=11550 nm, and the grating periodic length is 1550 nm; and

FIG. 5 illustrates the dependence of the penetrating rate on polarized light in different polarization states (P and S) for the first embodiment filter with 18 layers at 0°, 10°, and 20°, the thickness of each film layer of the filter being λ/4, wherein λ=1550 nm, and the grating periodic length is 3100 nm.

### DETAILED DESCRIPTION OF THE INVENTION

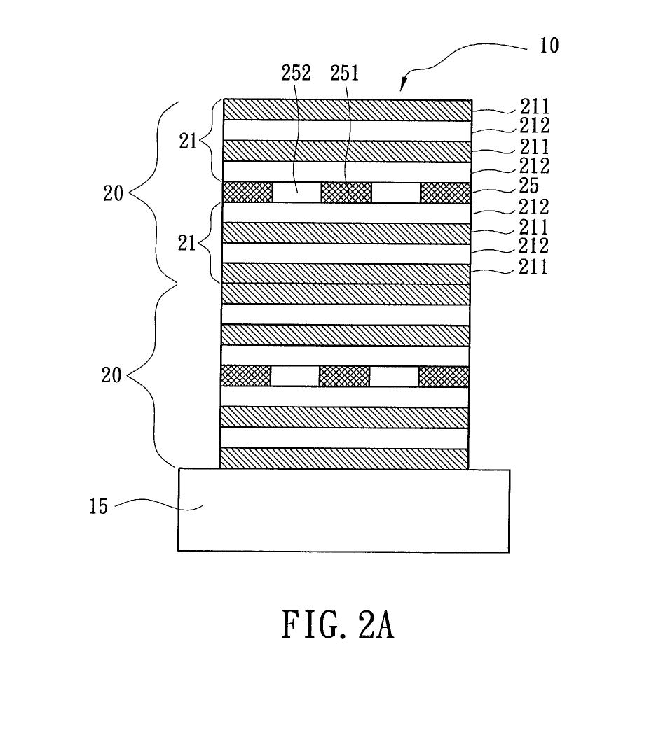

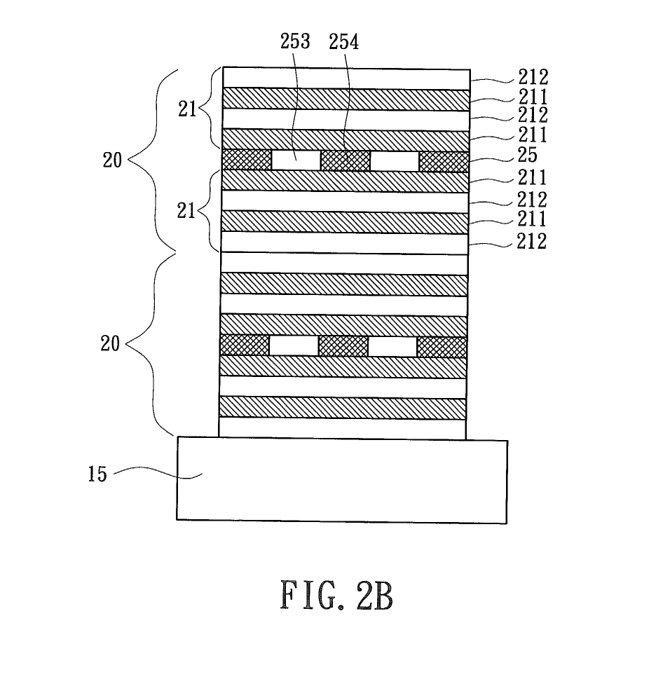

With reference to FIG. 2A, the filter is a structure 10 of symmetric dual resonance cavities formed on a glass substrate 15 (which can be formed by stacking several sets of the dual resonance cavity symmetry structure). The structure 10 is formed by stacking two Fabry-Perot b and pass filters with single resonance cavities 20. The resonance cavity 20 is formed by stacking high refraction index film layers and low refraction index film layers interposedly together. A preferred number of layers is nine, with the middle (the fifth) layer as a spacer 25, thus separating the resonance cavity 20 into upper and lower reflective surface symmetric reflectors 21.

The reflector 21 is formed by stacking together high refraction index layers 211 (such as an Si layer with the refraction index n_{H}=3.6) and low refraction index layers 212 (such as an SiO₂ layer with the refraction index n_{L}=1.43). The neighboring film layers of the spacer 25 are the low refraction index layers 212. The spacer 25 is an effectively high refraction index resonance grating, which is a periodic grating structure formed with a high refraction index material 251 (such as Si with the refraction index n_{gH}=3.6) and a low refraction index material 252 (such as SiOₓ with the refraction index 3.5>n_{gL}≧3.1) in a proper ratio width (f=0.1˜0.9). The effective refraction index n_{g} of the resonance grating is preferably between 3.4 and 3.5. The grating periodic length is between 0.9 λ and 3 λ and preferably between 1 λ and 2 λ, where λ is the wavelength of the penetrating light.

If the reflector film layer next to the spacer 25 is a high refraction index layer 211, as shown in FIG. 2B, the spacer 25 is then a resonance grating with an effectively low refraction index. The spacer 25 is a periodic grating structure formed with a low refraction index material 253 (such as SiO₂ with the refraction index n_{gL}=1.43) and a high refraction index material 254 (such as SiOₓ with the refraction index 1.6≧n_{gH}>1.43) in a proper ratio width (f=0.1˜0.9). The effective refraction index n_{g} of the resonance grating is preferably between 1.45 and 1.5. The grating periodic length is between 0.9 λ and 3 λ and preferably between 1 λ and 2 λ, where λ is the wavelength of the penetrating light.

The film layer materials in the above two embodiments, i.e., Si, SiO₂, and SiOₓ, can be made by a physical vapor deposition (PVD) process, e.g., reactive magnetron sputtering or vapor deposition of Si (R. -Y. Tsai et al., “Effect of oxygen in reactive ion-assisted bipolar DC magnetron sputtering of Ta₂O₅ and SiO₂ films,” J. of Vac. Sci. of R.O.C., in press) or .by a plasma-enhanced chemical vapor deposition process, e.g., using SiH₄ and N₂O in deposition (R. -Y. Tsai et al., “Amorphous silicon and amorphous silicon nitride films prepared by a plasma-enhanced chemical vapor deposition process as optical coating materials,” Appl. Opt. 32, 5561-5566, 1993). The grating can be formed by electron beam etching (S. Kaushik and B. R. Stallard, “Optical filter including a subwavelength periodic structure and method of making”, the U.S. Pat. 5,726,805; Y. Kanamori, M. Sasaki, and K. Hane, “Broadband antireflection gratings fabricated upon silicon substrate,” Opt. Letts. 24, 1422-1424, 1999) or oxygen ion implantation (F. Flory et al., “Enhancement of the diffraction efficiency of titanium implanted gratings by association them with optical interference coatings,” SPIE 3738, 306-315, 1999).

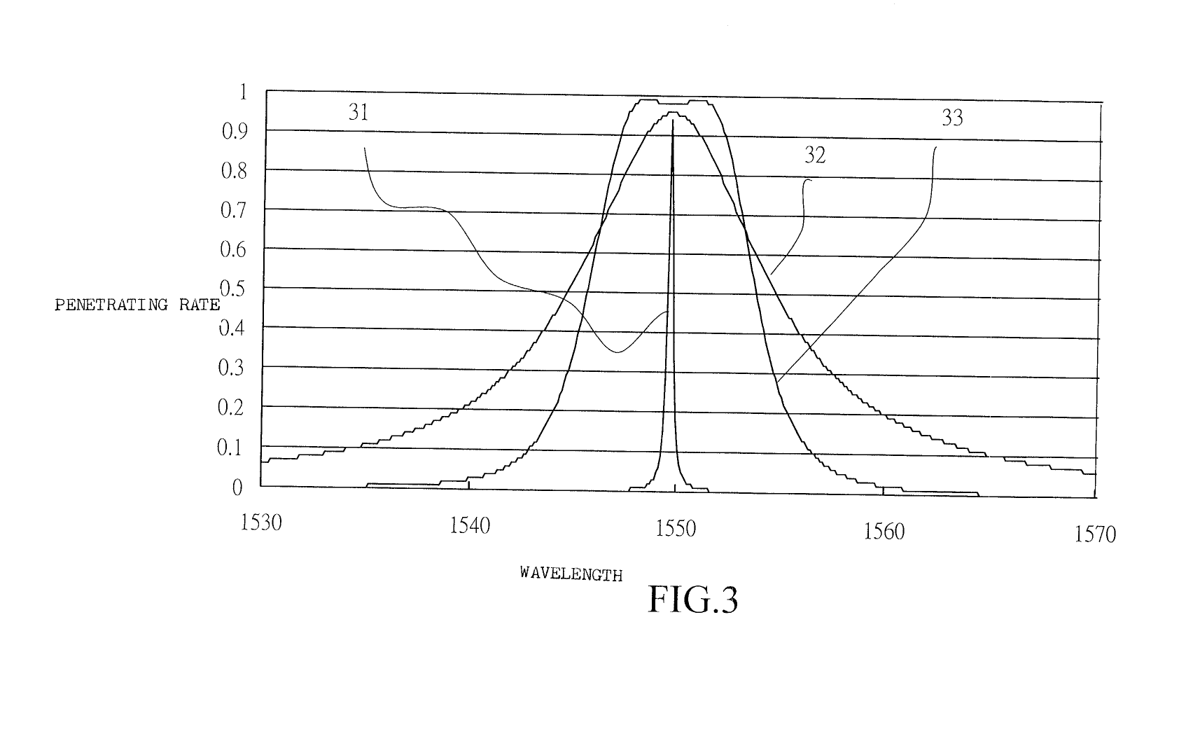

With reference to FIG. 3, the penetrating rate curve 32 of the conventional 9-layer thin film Fabry-Perot band pass filter (FP-9) and the penetrating rate curve 33 of the conventional 19-layer thin film Fabry-Perot band pass filter (FP-19) are much wider than the penetrating rate curve 31 of the disclosed 18-layer polarization-independent ultra-narrow band pass filter (GMR-18). The curve 31 does not only have very strong high band pass penetrating signals but can also narrow down the low band pass penetrating signals to extremely low. The half bandwidth Δλ of the penetrating signals is smaller than 0.2 nm.

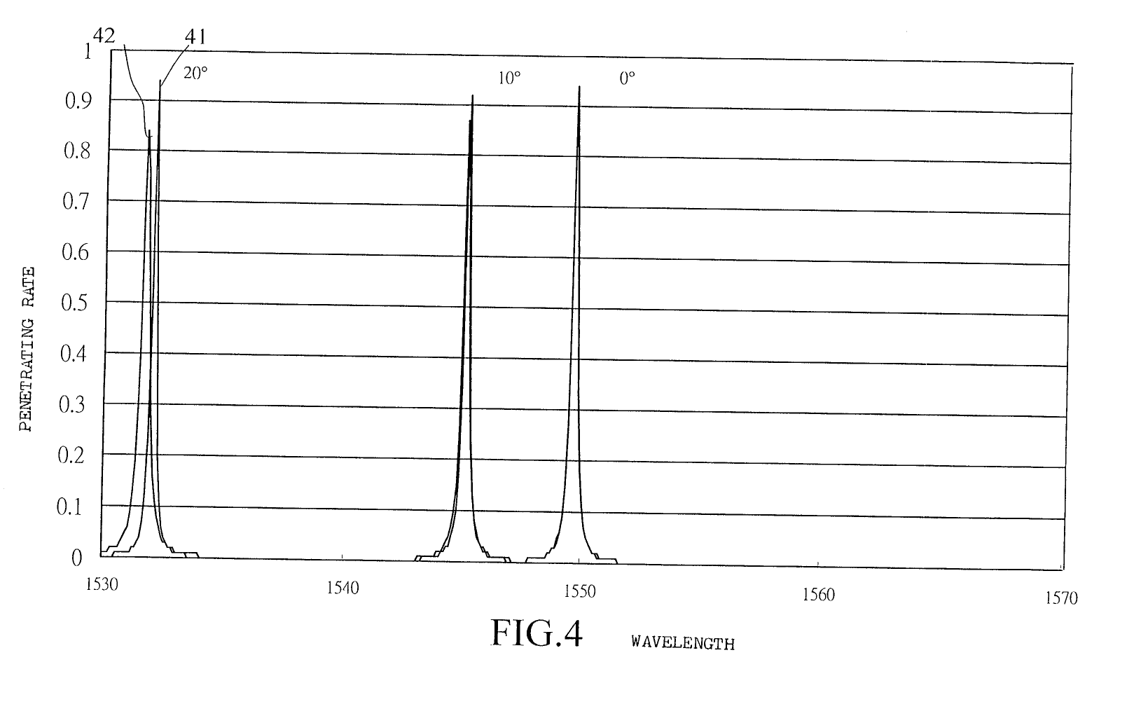

With reference to FIG. 4, each resonance cavity of the filter has nine layers of films with each film layer being λ/4 thick and λ=1550 nm. The spacer of the resonance cavity is a resonance grating composed of a high refraction index material Si (refraction index n_{gH}=3.6) and a low refraction index material SiOₓ, (refraction index n_{gL}=3.4) in an equal width proportion (f=0.5). The effective refraction index of the resonance grating is n_{g}=f×n_{gH}+(1−f)×n_{L}=3.5 and the grating periodic length is 1550 nm. In the reflector of the resonance cavity, the high refraction index layer is an Si layer (refraction index n_{H}=3.6) and the low refraction index layer is an SiOₓ layer (refraction index n_{L}=1.43). The drawing shows that the penetrating wavelengths of incident beams with different polarizations at 0° and 10° differ very little. The difference between the wavelengths of TE-20 41 and TM-20 42 becomes apparent at 20°.

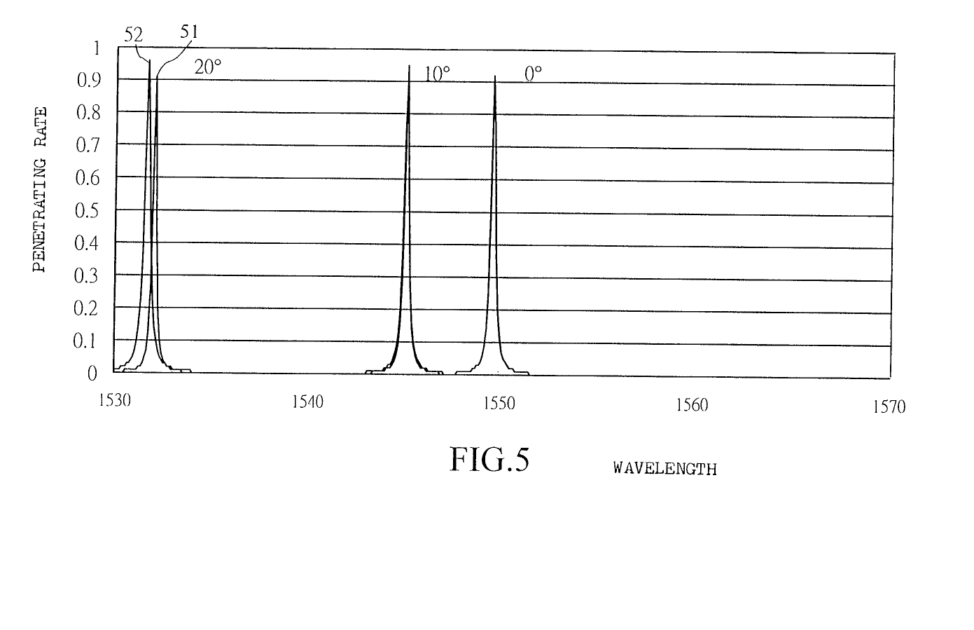

With reference to FIG. 5, each resonance cavity of the filter has nine layers of films with each film layer being λ/4 thick and λ=1550 nm. The spacer of the resonance cavity is a resonance grating composed of a high refraction index material Si (refraction index n_{gH}=3.6) and a low refraction index material SiOₓ, (refraction index n_{gL}=3.4) in an equal width proportion (f=0.5). The effective refraction index of the resonance grating is n_{g}=f×n_{gH}+(1−f)×n_{gL}=3.5 and the grating periodic length is 3100 nm. In the reflector of the resonance cavity, the high refraction index layer is an Si layer (refraction index n_{H}=3.6) and the low refraction index layer is an SiOₓ layer (refraction index n_{L}=1.43). Similarly, the drawing shows that the penetrating wavelengths of incident beams with different polarizations at 0° and 10° differ very little. The difference between the wavelengths of TE-20 51 and TM-20 52 becomes apparent at 20°.

Although the invention has been described with reference to specific embodiments, this description is not meant to be construed in a limiting sense. Various modifications of the disclosed embodiments, as well as alternative embodiments, will be apparent to persons skilled in the art. For example, the number of film layers in the resonance cavity can be 5, 13 or other proper numbers. The two reflectors of the resonance cavity are not necessarily symmetric to the spacer; that is, they can have different numbers of layers. It is, therefore, contemplated that the appended claims will cover all modifications that fall within the true scope of the invention.

What is claimed is:

1. A polarization-independent ultra-narrow band pass filter to allow light with a wavelength λ to pass through, which is characterized in that: the polarization-independent ultra-narrow band pass filter comprises at least one set of dual symmetric resonance cavities, the structure of the dual symmetric resonance cavities is formed by stacking two Fabry-Perot band pass filters with single resonance cavities, each of the resonance cavities being composed of two reflectors with a resonance grating sandwiched in between; wherein the reflector is formed by stacking high refraction index layers and low refraction index layers interposedly together and the high refraction index layers, the low refraction index layers, and the resonance grating are all λ/4 thick with the grating periodic length of the resonance grating being between 0.9 λ and 3 λ.

2. The polarization-independent ultra-narrow band pass filter of claim 1, wherein the grating periodic length of the resonance grating is preferably between 1 λ and 2 λ.

3. The polarization-independent ultra-narrow band pass filter of claim 1, wherein its structure is {(HL)^{x}2H(LH)^{x}}^{m}, with H being a high refraction index (or effective refraction index) film layer, L being a low refraction index (or effective refraction index) film layer, and 3≦x≦5, m≧1.

4. The polarization-independent ultra-narrow band pass filter of claim 1, wherein its structure is {(LH)^{x}2L(HL)^{x}}^{m}, with H being a high refraction index (or effective refraction index) film layer, L being a low refraction index (or effective refraction index) film layer, and 3≦x≦5, m≧1.

5. The polarization-independent ultra-narrow band pass filter of claim 1, wherein its structure is {(LH)^{x}2L(LH)^{x}L}^{m}, with H being a high refraction index (or effective refraction index) film layer, L being a low refraction index (or effective refraction index) film layer, and 3≦x≦5, m≧1.

6. The polarization-independent ultra-narrow band pass filter of claim 1, wherein its structure is {(LH)^{x}2H(HL)^{x}H}^{m}, with H being a high refraction index (or effective refraction index) film layer, L being a low refraction index (or effective refraction index) film layer, and 3≦x≦5, m≧1.

7. The polarization-independent ultra-narrow band pass filter of claim 1, wherein the high refraction index layer is made of Si (with a refraction index of 3.6) and the low refraction index layer is made of SiO₂ (with a refraction index of 1.43).

8. The polarization-independent ultra-narrow band pass filter of claim 1, wherein the film layer of the reflector next to the resonance grating is a high refraction index layer and the resonance grating is a film layer with a low effective refraction index.

9. The polarization-independent ultra-narrow band pass filter of claim 8, wherein the resonance grating is a periodic structure composed of low refraction index materials SiO₂ (with a refraction index of 1.43) and SiOₓ (with a refraction index 1.6≧n_{gH}>1.43).

10. The polarization-independent ultra-narrow band pass filter of claim 9, wherein the width proportion f between the low refraction index materials of the resonance grating ranges from 0.1 to 0.9 and the effective refraction index n_{g} of the resonance grating ranges from 1.45 to 1.5.

11. The polarization-independent ultra-narrow band pass filter of claim 1, wherein the film layer of the reflector next to the resonance grating is a low refraction index layer and the resonance grating is a film layer with a high effective refraction index.

12. The polarization-independent ultra-narrow band pass filter of claim 11, wherein the resonance grating is a periodic structure composed of high refraction index materials Si (with a refraction index of 3.6) and SiOₓ (with a refraction index 1.6≧n_{gL}>1.43).

13. The polarization-independent ultra-narrow band pass filter of claim 12, wherein the width proportion f between the high refraction index materials of the resonance grating ranges from 0.1 to 0.9 and the effective refraction index n_{g} of the resonance grating ranges from 3.4 to 3.5.

14. The polarization-independent ultra-narrow band pass filter of claim 7, wherein each film layer is made by employing reactive sputtering, vapor deposition or plasma enhanced chemical vapor deposition (CVD).

15. The polarization-independent ultra-narrow band pass filter of claim 9, wherein the resonance grating is formed by electron beam or laser etching, ion implantation, or laser exposure.

16. The polarization-independent ultra-narrow band pass filter of claim 1, wherein the at least one set of dual symmetric resonance cavities is configured on a glass substrate.

17. The polarization-independent ultra-narrow band pass filter of claim 9, wherein each film layer is made by employing reactive sputtering, vapor deposition or plasma enhanced chemical vapor deposition (CVD).

18. The polarization-independent ultra-narrow band pass filter of claim 12, wherein each film layer is made by employing reactive sputtering, vapor deposition or plasma enhanced chemical vapor deposition (CVD).

19. The polarization-independent ultra-narrow band pass filter of claim 12, wherein the resonance grating is formed by electron beam or laser etching, ion implantation, or laser exposure.
